(19) United States
(12) Patent Application Publication
(10) Pub. No.: US 2021/0273889 A1
(43) Pub. Date: Sep. 2, 2021

(54) COMMUNICATION CONTROL APPARATUS, METHOD, PROGRAM, AND NON-TRANSITORY COMPUTER READABLE RECORDING MEDIUM

(71) Applicant: NEC Corporation, Minato-ku, Tokyo (JP)

(72) Inventor: Toru OSUGA, Tokyo (JP)

(73) Assignee: NEC Corporation, Minato-ku, Tokyo (JP)

(21) Appl. No.: 17/258,299

(22) PCT Filed: Jun. 27, 2019
(86) PCT No.: PCT/JP2019/025630

§ 371 Date: Jan. 6, 2021

(30) Foreign Application Priority Data
Jul. 9, 2018 (JP) 2018-129929

(51) Int. Cl. H04L 12/825; H04L 12/841; H04L 12/823; H04L 12/801

(52) U.S. Cl. CPC H04L 47/263; H04L 47/283; H04L 1/0002; H04L 47/12; H04L 47/32

(57) ABSTRACT

A communication control apparatus includes: a first communication processing section configured to receive one or more packets from a transmitting apparatus, the one or more packets being transmitted from the transmitting apparatus to a receiving apparatus and being unable to be generated and modified at a relay point; and a second communication processing section configured to transmit the one or more packets to the receiving apparatus, wherein the second communication processing section receives, from the receiving apparatus, one or more acknowledgement packets for the one or more packets, the one or more acknowledgement packets being unable to be generated and modified at a relay point, and wherein the first communication processing section transmits the one or more acknowledgement packets to the transmitting apparatus, the communication control apparatus further including a control section configured to control the one or more packets or the one or more acknowledgement packets.

### BACKGROUND

### Technical Field

The present invention relates to a communication control apparatus, a method, a program, and a non-transitory computer readable recording medium.

### Background Art

In recent years, the traffic via a mobile network has been increasing as highly functional mobile terminals such as a smartphone and a tablet become more and more widespread.

In transmission rate control (for example, CUBIC, NewReno, and the like) used in many types of communication, it is difficult to follow such a rapid band variation in the mobile network. For such reasons, the bands are not used sufficiently, and throughput may be reduced.

There is a technique of adjusting a transmission rate in a relay apparatus that relays packets from a transmitting apparatus to a receiving apparatus. For example, PTL 1 discloses the following technique: in a relay apparatus, an acknowledgement (ACK) that is transmitted, normally by a receiving apparatus, to a transmitting apparatus for data received from the transmitting apparatus is transmitted to the transmitting apparatus instead of the receiving apparatus, and the data is transmitted to the receiving apparatus by adjusting the transmission rate. PTL 2 discloses roughly the same technique as well. PTL 3 discloses the following technique: in a relay apparatus, an available band of a network is estimated, a target transmission rate is estimated based on the available band, and frequency of transmission of ACK packets to the transmitting apparatus is adjusted so that the target transmission rate becomes closer to the current transmission rate.

### CITATION LIST

### Patent Literature

[PTL 1] JP 2003-124984 A

[PTL 2] WO 2015/048999 A1

[PTL 3] JP 2018-067788 A

### SUMMARY

### Technical Problem

The techniques of PTLs 1 to 3 presuppose a configuration in which the relay apparatus is able to generate or modify ACK packets on behalf of another entity and transmit the ACKs to the transmitting apparatus.

However, in some cases, the relay apparatus is not able to generate and modify the ACK packets due to a protocol to be used. As an example, the ACK packets are encrypted or authenticated, and the relay apparatus may be unable to generate and modify the ACK packets to transmit and receive the ACK packets. When the ACK packets are encrypted, the relay apparatus is unable to know acknowledgement numbers of the ACK packets, and thus cannot determine whether the packets have normally arrived or have been lost. Accordingly, the relay apparatus cannot transmit the ACK packets for prompting retransmission of lost packets. In such a case, it is difficult to apply the techniques of PTLs 1 to 3.

The example object of the present invention is to provide a communication control apparatus and a method that enable enhancement of throughput of communication between a transmitting apparatus and a receiving apparatus regardless of a protocol to be used.

### Solution to Problem

A communication control apparatus according to an example aspect of the present invention includes: a first communication processing section configured to receive one or more packets from a transmitting apparatus, the one or more packets being transmitted from the transmitting apparatus to a receiving apparatus and being unable to be generated and modified at a relay point between the transmitting apparatus and the receiving apparatus; and a second communication processing section configured to transmit the one or more packets to the receiving apparatus, wherein the second communication processing section receives, from the receiving apparatus, one or more acknowledgement packets for the one or more packets, the one or more acknowledgement packets being unable to be generated and modified at a relay point between the receiving apparatus and the transmitting apparatus, and wherein the first communication processing section transmits the one or more acknowledgement packets to the transmitting apparatus, the communication control apparatus including a control section configured to control the one or more packets or the one or more acknowledgement packets so that the transmitting apparatus changes a transmission rate.

A method according to an example aspect of the present invention includes: receiving one or more packets from a transmitting apparatus, the one or more packets being transmitted from the transmitting apparatus to a receiving apparatus and being unable to be generated and modified at a relay point between the transmitting apparatus and the receiving apparatus; transmitting the one or more packets to the receiving apparatus; receiving, from the receiving apparatus, one or more acknowledgement packets for the one or more packets, the one or more acknowledgement packets being unable to be generated and modified at a relay point between the receiving apparatus and the transmitting apparatus; transmitting the one or more acknowledgement packets to the transmitting apparatus; and controlling the one or more packets or the one or more acknowledgement packets so that the transmitting apparatus changes a transmission rate.

A program according to an example aspect of the present invention is a program that causes a processor to execute: receiving one or more packets from a transmitting apparatus, the one or more packets being transmitted from the transmitting apparatus to a receiving apparatus and being unable to be generated and modified at a relay point between the transmitting apparatus and the receiving apparatus; transmitting the one or more packets to the receiving apparatus; receiving, from the receiving apparatus, one or more acknowledgement packets for the one or more packets, the one or more acknowledgement packets being unable to be generated and modified at a relay point between the receiving apparatus and the transmitting apparatus; transmitting the one or more acknowledgement packets to the transmitting apparatus; and controlling the one or more packets or the one or more acknowledgement packets so that the transmitting apparatus changes a transmission rate.

A non-transitory computer-readable recording medium according to an example aspect of the present invention is a non-transitory computer readable recording medium storing a program that causes a processor to execute: receiving one or more packets from a transmitting apparatus, the one or more packets being transmitted from the transmitting apparatus to a receiving apparatus and being unable to be generated and modified at a relay point between the transmitting apparatus and the receiving apparatus; transmitting the one or more packets to the receiving apparatus; receiving, from the receiving apparatus, one or more acknowledgement packets for the one or more packets, the one or more acknowledgement packets being unable to be generated and modified at a relay point between the receiving apparatus and the transmitting apparatus; transmitting the one or more acknowledgement packets to the transmitting apparatus; and controlling the one or more packets or the one or more acknowledgement packets so that the transmitting apparatus changes a transmission rate.

### Advantageous Effects of Invention

According to the present invention, enhancement of throughput of communication between a transmitting apparatus and a receiving apparatus is enabled regardless of a protocol to be used. Note that, according to the present invention, instead of or together with the above effects, other effects may be exerted.

### BRIEF DESCRIPTION OF THE DRAWINGS

FIG. 1 is an explanatory diagram for describing an example of variation of a congestion window (cwnd) in CUBIC.

FIG. 2 is an explanatory diagram for describing a method of adjustment of a transmission data amount in BBR.

FIG. 3 is a graph illustrating an example of variation of a radio band and variation of throughput using transmission rate control (CUBIC).

FIG. 4 is an explanatory diagram for describing an example of a QUIC packet.

FIG. 5 is an explanatory diagram illustrating an example of a schematic configuration of a system according to example embodiments.

FIG. 6 is a block diagram illustrating an example of a schematic functional configuration of a communication control apparatus according to a first example embodiment.

FIG. 7 is a block diagram illustrating an example of a schematic hardware configuration of the communication control apparatus according to the first example embodiment.

FIG. 8 is a sequence diagram for describing an example of transmission of packets from a transmitting apparatus 10 to a receiving apparatus 20 according to the first example embodiment.

FIG. 9A is a sequence diagram for describing a first example of adjustment of transmission timing according to the first example embodiment.

FIG. 9B is a sequence diagram for describing a second example of adjustment of transmission timing according to the first example embodiment.

FIG. 10 is a sequence diagram for describing a third example of adjustment of transmission timing according to the first example embodiment.

FIG. 11 is a sequence diagram for describing an example of adjustment of transmission order of packets according to the first example embodiment.

FIG. 12 is a sequence diagram for describing an example of discarding of a part of ACK packets according to the first example embodiment.

FIG. 13 is a block diagram illustrating an example of a schematic functional configuration of a communication control apparatus according to a second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Related Art

2. Configuration of System according to Example Embodiments

3. First Example Embodiment
3.1. Functional Configuration of Communication Control Apparatus
3.2. Hardware Configuration of Communication Control Apparatus
3.3. Technical Features

4. Second Example Embodiment
4.1. Functional Configuration of Communication Control Apparatus
4.2. Hardware Configuration of Communication Control Apparatus
4.3. Technical Features

In the present disclosure, the expression “A and/or B” means “both A and B” or “either A or B”.

### 1. RELATED ART

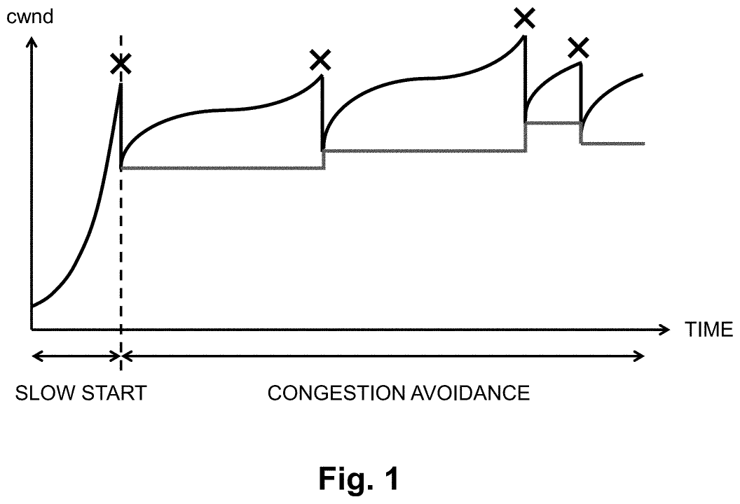

With reference to FIG. 1 to FIG. 4, the technique related to example embodiments of the present invention will be described.

### (1) CUBIC

CUBIC is a congestion control scheme standardly used in the Transmission Control Protocol (TCP) of Linux (registered trademark) kernel 2.6.19 or later versions. It can be said that CUBIC is a scheme for controlling a transmission rate based on whether or not packet loss occurs, and is a loss-based scheme.

FIG. 1 is an explanatory diagram for describing an example of a variation of a congestion window (cwnd) in CUBIC.

First, in a slow start phase, a transmitting apparatus increments cwnd by one packet for each reception of an ACK. In the phase, cwnd is exponentially incremented in the time axis. The increment continues until cwnd reaches a predetermined threshold (initial ssthresh).

Next, in a congestion avoidance phase, the transmitting apparatus increments cwnd in a manner of a cubic function over the course of time as long as the transmitting apparatus normally receives the ACK. On the other hand, when the transmitting apparatus receives a duplicate acknowledgement (DupACK) for the same packet three times, the transmitting apparatus determines that it is light congestion and decrements cwnd at a certain ratio (for example, by 30 percent), and when the time is out, the transmitting apparatus determines that it is severe congestion and sets cwnd to be two packets. In the example of FIG. 1, in the congestion avoidance phase, the transmitting apparatus increments cwnd while the transmitting apparatus normally receives the ACK, but decrements cwnd according to occurrence of DupACK or the like along with congestion.

In this manner, in CUBIC, the transmitting apparatus increments and decrements cwnd according to a reception condition of the ACK. In other words, the transmitting apparatus changes the transmission rate according to a reception condition of the ACK.

### (2) BBR

BBR (Bottleneck Bandwidth and Round-trip propagation time) is a congestion control scheme available in TCP, QUIC, or the like of recent years. It can be said that BBR is a scheme for controlling a transmission rate based on network performance that is estimated from transmission and reception of packets, and is a function-based scheme.

Specifically, in BBR, the transmitting apparatus estimates the network performance while transmitting data, and determines a transmission data amount based on estimation results. Unlike CUBIC, control of the transmission data amount is not performed even when packet loss occurs.

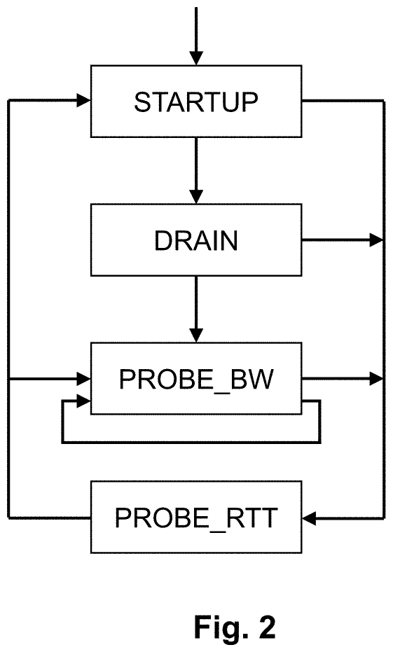

In BBR, data is transmitted by adjusting a “pace” and an “upper limit” of the transmission data amount, and an “available band” and a “communication delay” are continuously estimated. Specifically, as illustrated in FIG. 2, the transmitting apparatus makes the pace faster and increases the upper limit with “STARTUP”, makes the pace slower and increases the upper limit with “DRAIN”, makes the pace ordinary (only slightly vary) and makes the upper limit ordinary with “PROBE_BW”, and makes the pace ordinary and reduces the upper limit to be local minimum with “PROBE_RTT”.

The transmitting apparatus estimates a maximum value of “arrival confirmation data amount/elapsed time” within a certain period of time as the “available band”, and estimates a minimum value of round trip time (RTT) within a certain period of time as the “communication delay”. The “available band” is referred to as BtlBw (Bottleneck Bandwidth), and the “communication delay” is referred to as RTprop (Round-Trip propagation time).

In addition, the transmitting apparatus calculates the “transmission data amount” by multiplying the “available band” and the “communication delay”. The “transmission data amount” is referred to as Bandwidth-Delay Product (BDP).

### (3) Throughput in Mobile Network

In recent years, the traffic via a mobile network has been increasing as highly functional mobile terminals such as a smartphone and a tablet become more and more widespread. In transmission rate control (for example, CUBIC, NewReno, and the like) used in many types of communication, it is difficult to follow such a rapid band variation in the mobile network.

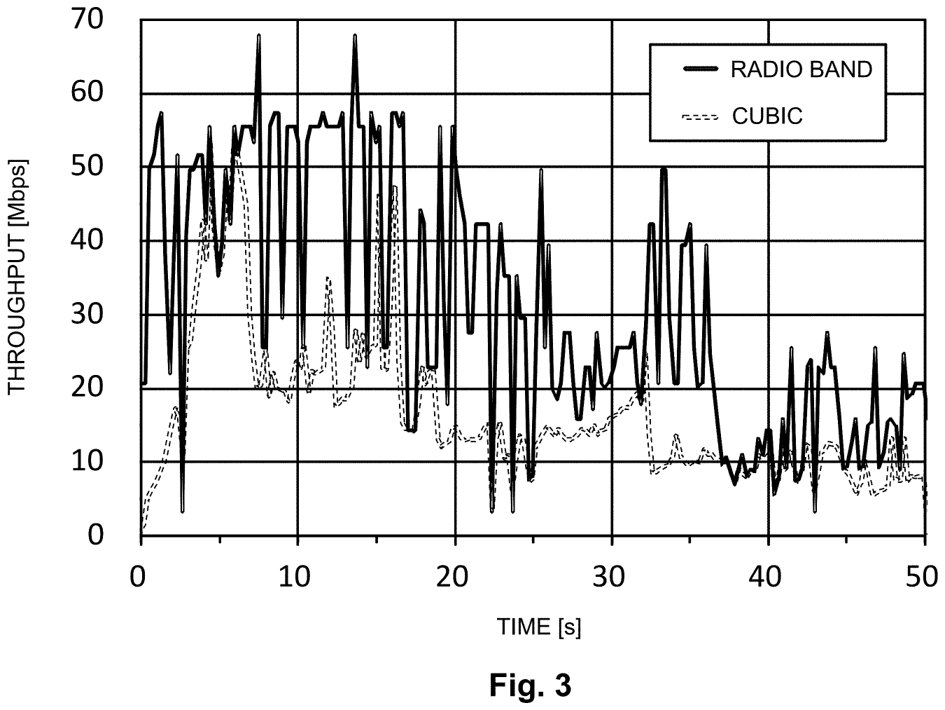

FIG. 3 is a graph illustrating an example of variation of a radio band and variation of throughput using the transmission rate control (CUBIC). With reference to FIG. 3, throughput varies due to the transmission rate control (CUBIC) using CUBIC according to variation of the radio band. However, because of sharp variation of the radio band, the throughput fails to sufficiently follow the variation.

### (4) QUIC

Quick UDP Internet Connections (QUIC) are the transport protocol, and are used as a higher layer protocol of the User Datagram Protocol (UDP). QUIC has a configuration for packets in which operation such as generation and modification of packets in an intermediate apparatus is extremely difficult.

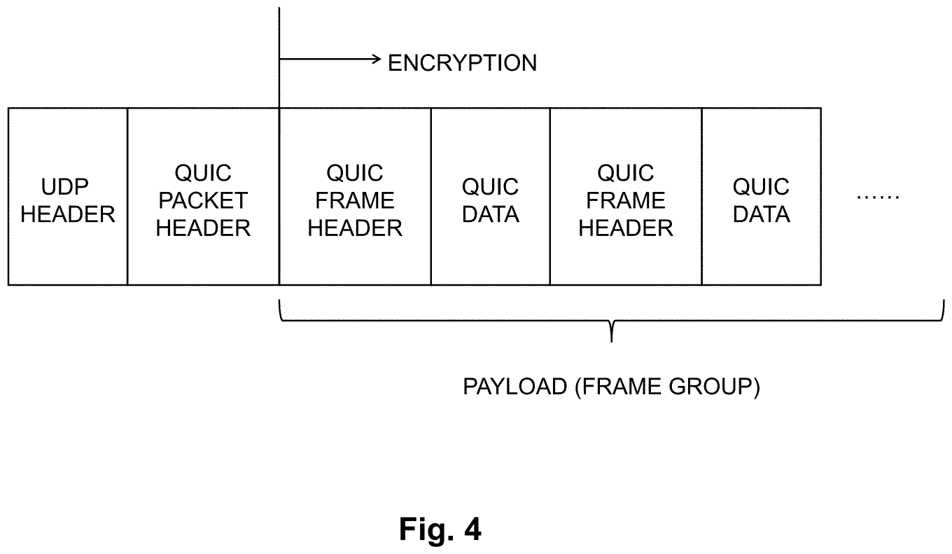

FIG. 4 is an explanatory diagram for describing an example of a QUIC packet. With reference to FIG. 4, a QUIC packet is illustrated as a service data unit (SDU) of a UDP packet.

The QUIC packet includes a QUIC packet header and a payload, and the payload includes one or more QUIC frames. Each QUIC frame includes a QUIC frame header and QUIC data. The payload in the QUIC packet is encrypted. The QUIC packet header is not encrypted but is authenticated, and cannot be modified.

### 2. CONFIGURATION OF SYSTEM ACCORDING TO EXAMPLE EMBODIMENTS

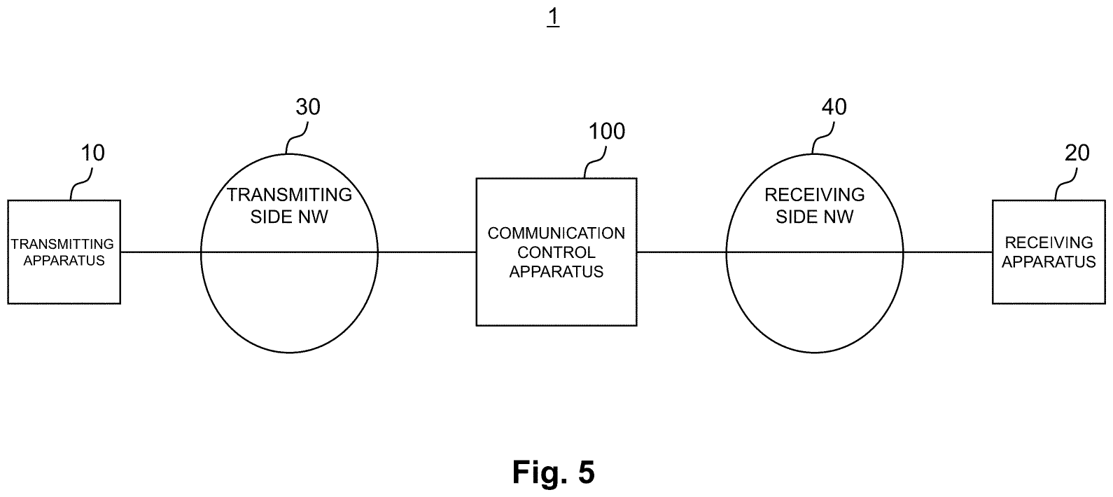

With reference to FIG. 5, an example of a configuration of a system according to example embodiments of the present invention will be described.

FIG. 5 is an explanatory diagram illustrating an example of a schematic configuration of a system 1 according to example embodiments of the present invention. With reference to FIG. 5, the system 1 includes a transmitting apparatus 10, a receiving apparatus 20, and a communication control apparatus 100. The communication control apparatus 100 may be referred to as a relay apparatus.

The transmitting apparatus 10 transmits one or more packets to the receiving apparatus 20. The communication control apparatus 100 is located between the transmitting apparatus 10 and the receiving apparatus 20, and transfers (or relays) the packets. Specifically, the communication control apparatus 100 receives the packets from the transmitting apparatus 10 via a transmitting side network 30, and transmits the packets to the receiving apparatus 20 via a receiving side network 40. For example, the packets are data packets.

As an example, when a user downloads contents, the transmitting apparatus 10 may be a server, and the receiving apparatus 20 may be a personal computer (PC) or a smartphone. In this case, the receiving side network 40 may be a mobile network, may be the Internet, or may include the Internet and the mobile network. Alternatively, when a user uploads contents, the transmitting apparatus 10 may be a personal computer (PC) or a smartphone, and the receiving apparatus 20 may be a server. As a matter of course, the transmitting apparatus 10 and the receiving apparatus 20 are not limited to the examples described above.

The transmitting apparatus 10 controls a transmission rate by using a transmission control scheme. As an example, the transmission control scheme is a first transmission control scheme (for example, a loss-based transmission control scheme such as CUBIC) for controlling a transmission rate based on whether or not packet loss occurs. Alternatively, the transmission control scheme is a second transmission control scheme (for example, a function-based transmission control scheme such as BBR) for controlling a transmission rate based on network performance that is estimated from transmission and reception of packets. As a matter of course, the transmission control scheme is not limited to these examples. Note that the transmission control scheme may also be referred to as a congestion control scheme.

### 3. FIRST EXAMPLE EMBODIMENT

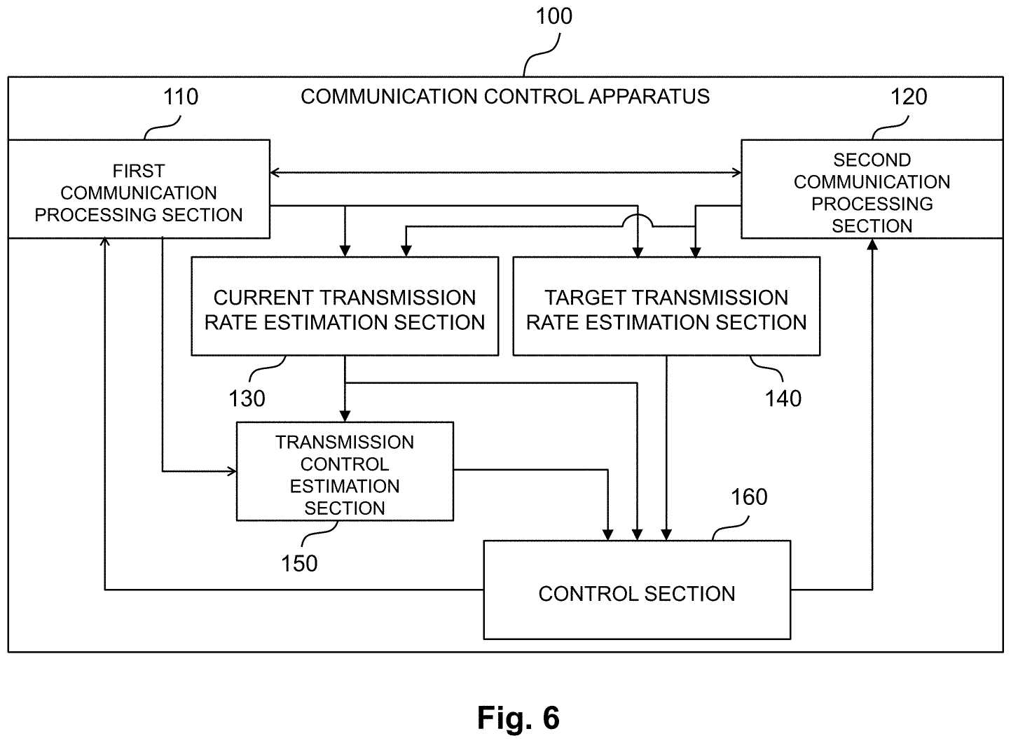

With reference to FIG. 6 to FIG. 12, a first example embodiment of the present invention will be described.

### 3.1. Functional Configuration of Communication Control Apparatus

FIG. 6 is a block diagram illustrating an example of a schematic functional configuration of the communication control apparatus 100 according to the first example embodiment. With reference to FIG. 6, the communication control apparatus 100 includes a first communication processing section 110, a second communication processing section 120, a current transmission rate estimation section 130, a target transmission rate estimation section 140, a transmission control estimation section 150, and a control section 160.

The first communication processing section 110 transmits and receives packets. For example, the first communication processing section 110 receives packets (for example, data packets) from the transmitting apparatus 10, and transmits packets (for example, ACK packets) to the transmitting apparatus 10.

The second communication processing section 120 transmits and receives packets. For example, the second communication processing section 120 transmits packets (for example, data packets) to the receiving apparatus 20, and receives packets (for example, ACK packets) from the receiving apparatus 20.

The first communication processing section 110 and the second communication processing section 120 perform processing of one or more protocol layers, for example. Specifically, for example, the one or more protocol layers include a protocol layer of layer 3 (network layer) or a higher layer. The one or more protocol layers may further include a protocol layer of layer 2 or a lower layer. Alternatively, the one or more protocol layers may only include the protocol layer of layer 2 or a lower layer. The first communication processing section 110 and the second communication processing section 120 may be integrated as one communication processing section.

The current transmission rate estimation section 130 estimates the current transmission rate between the transmitting apparatus 10 and the receiving apparatus 20, for each of sessions or streams related to the packets transferred by the communication control apparatus 100.

The target transmission rate estimation section 140 estimates a target transmission rate between the transmitting apparatus 10 and the receiving apparatus 20, for each of sessions or streams related to the packets transferred by the communication control apparatus 100.

The transmission control estimation section 150 estimates the transmission control scheme used by the transmitting apparatus 10, for each of sessions or streams related to the packets transferred by the communication control apparatus 100.

The control section 160 performs control of the packets transmitted from the transmitting apparatus to the receiving apparatus. For example, the control is control of the ACK packets (the ACK packets that are received by the second communication processing section 120 from the receiving apparatus 20 and are transmitted by the first communication processing section 110 to the transmitting apparatus 10) for the packets, or of the packets (the data packets that are received by the first communication processing section 110 from the transmitting apparatus 10 and are transmitted by the second communication processing section 120 to the receiving apparatus 20). The control section 160 may perform indirect control of the ACK packets or the packets by controlling operation of the first communication processing section 110 or the second communication processing section 120. Alternatively, the control section 160 may perform direct control of the ACK packets or the packets by directly processing the ACK packets or the packets between the first communication processing section 110 and the second communication processing section 120.

More specific operations of the first communication processing section 110, the second communication processing section 120, the current transmission rate estimation section 130, the target transmission rate estimation section 140, the transmission control estimation section 150, and the control section 160 will be described later as technical features of the first example embodiment.

### 3.2. Hardware Configuration of Communication Control Apparatus

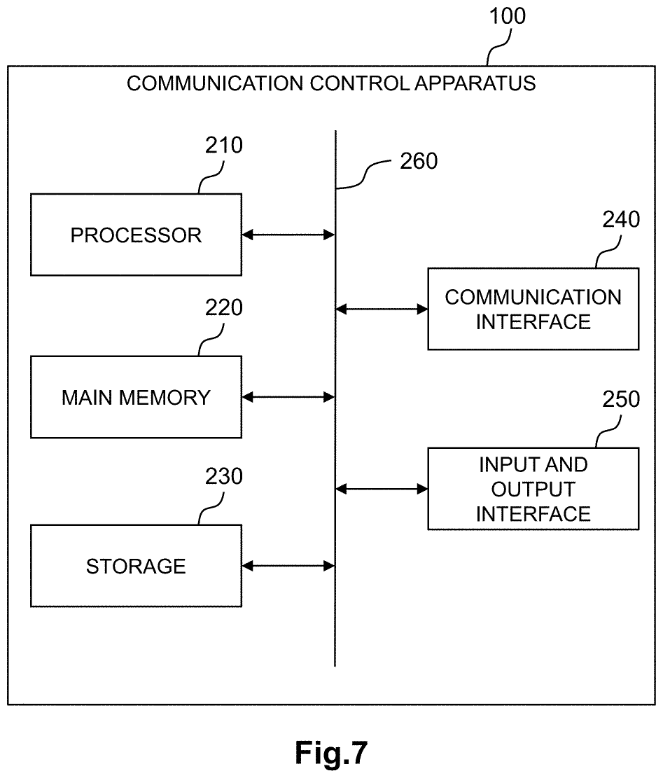

FIG. 7 is a block diagram illustrating an example of a schematic hardware configuration of the communication control apparatus 100 according to the first example embodiment. With reference to FIG. 7, the communication control apparatus 100 includes a processor 210, a main memory 220, a storage 230, a communication interface 240, and an input and output interface 250. The processor 210, the main memory 220, the storage 230, the communication interface 240, and the input and output interface 250 are connected to each other via a bus 260.

The processor 210 executes programs read from the main memory 220. As an example, the processor 210 is a central processing unit (CPU).

The main memory 220 stores programs and various pieces of data. As an example, the main memory 220 is a random access memory (RAM).

The storage 230 stores the programs and the various pieces of data. As an example, the storage 230 includes a solid state drive (SSD) and/or a hard disk drive (HDD).

The communication interface 240 is an interface for communication with another apparatus. As an example, the communication interface 240 is a network adapter or a network interface card.

The input and output interface 250 is an interface for connection with an input apparatus such as a keyboard and an output apparatus such as a display.

The first communication processing section 110 and the second communication processing section 120 may be implemented by the processor 210 and the main memory 220, or may be implemented by the processor 210, the main memory 220, and the communication interface 240. The current transmission rate estimation section 130, the target transmission rate estimation section 140, the transmission control estimation section 150, and/or the control section 160 may be implemented by the processor 210 and the main memory 220.

As a matter of course, the hardware configuration of the communication control apparatus 100 is not limited to the example described above. The communication control apparatus 100 may be implemented by another hardware configuration.

Alternatively, the communication control apparatus 100 may be virtual. In other words, the communication control apparatus 100 may be implemented as a virtual machine. In this case, the communication control apparatus 100 (the virtual machine) may operate as a physical machine (hardware) including a processor, a memory, and the like, and a virtual machine on a hypervisor.

The communication control apparatus 100 may include a memory (the main memory 220) configured to store the programs (instructions) and one or more processors (the processor(s) 210) that can execute the programs (instructions). The one or more processors may perform the operations of the first communication processing section 110, the second communication processing section 120, the current transmission rate estimation section 130, the target transmission rate estimation section 140, the transmission control estimation section 150, and/or the control section 160 by executing the programs. The programs may be programs for causing the processor(s) to execute the operations of the first communication processing section 110, the second communication processing section 120, the current transmission rate estimation section 130, the target transmission rate estimation section 140, the transmission control estimation section 150, and/or the control section 160.

### 3.3. Technical Features

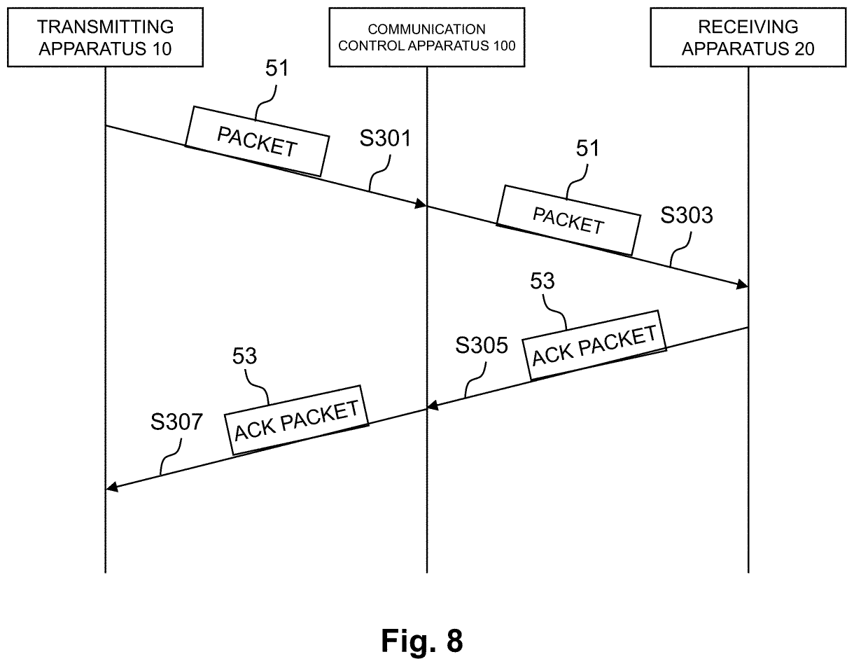

With reference to FIG. 8 to FIG. 12, technical features of the first example embodiment will be described.

### (1) Relay of Packets

The communication control apparatus 100 (the first communication processing section 110) receives, from the transmitting apparatus 10, the packets transmitted from the transmitting apparatus 10 to the receiving apparatus 20. Then, the communication control apparatus 100 (the second communication processing section 120) transmits the packets to the receiving apparatus 20.

For example, the packets are data packets. For example, the packets are packet data units (PDUs). Instead of being referred to as the packet, the packet may be referred to by other similar terms such as a frame, a datagram, or a segment.

In addition, the communication control apparatus 100 (the second communication processing section 120) receives acknowledgement (ACK) packets for the packets from the receiving apparatus 20. Then, the communication control apparatus 100 (the first communication processing section 110) transmits the acknowledgement (ACK) packets to the transmitting apparatus 10.

FIG. 8 is a sequence diagram for describing an example of transmission of the packets from the transmitting apparatus 10 to the receiving apparatus 20 according to the first example embodiment. The transmitting apparatus 10 transmits a packet (data packet) 51 to the receiving apparatus 20 (S301 and S303). In this case, the communication control apparatus 100 receives the packet 51 from the transmitting apparatus 10 (S301), and transmits the packet 51 to the receiving apparatus 20 (S303). In other words, the communication control apparatus 100 transfers (or relays) the packet 51 from the transmitting apparatus 10 to the receiving apparatus 20. In addition, the receiving apparatus 20 receives the packet 51 (S303), and transmits an ACK packet 53 for the packet 51 to the transmitting apparatus 10 (S305 and S307). In this case, the communication control apparatus 100 receives the ACK packet 53 from the receiving apparatus 20 (S305), and transmits the ACK packet 53 to the transmitting apparatus 10 (S307). In other words, the communication control apparatus 100 transfers (or relays) the packet 53 from the receiving apparatus 20 to the transmitting apparatus 10.

### (2) Packets and Acknowledgement (ACK) Packets

The packets transmitted from the transmitting apparatus 10 to the receiving apparatus 20 are packets that cannot be generated and modified in a relay point (for example, the communication control apparatus 100 or the like) between the transmitting apparatus 10 and the receiving apparatus 20.

In addition, the acknowledgement (ACK) packets for the packets are ACK packets that cannot be generated and modified in a relay point between the receiving apparatus 20 and the transmitting apparatus 10.

More specifically, for example, the packets and the ACK packets are at least partially encrypted or authenticated. In particular, the part of the ACK packets that is encrypted or authenticated includes information (for example, the acknowledgement number or the like) for the acknowledgement for the transmitting apparatus 10.

As a first example, the transmitting apparatus 10 transmits the packets that are at least partially authenticated, and the receiving apparatus 20 transmits the ACK packets that are at least partially authenticated. In this case, the packets and the ACK packets are authenticated, and thus the communication control apparatus 100 cannot generate and modify the packets and the ACK packets.

As a second example, the transmitting apparatus 10 transmits the packets that are at least partially encrypted, and the receiving apparatus 20 transmits the ACK packets that are at least partially encrypted. In this case, the packets and the ACK packets are encrypted, and thus the communication control apparatus 100 cannot generate and modify the packets and the ACK packets.

As an example, the packet is a QUIC packet (as that illustrated in FIG. 4, for example), and the ACK packet for the packet is also a QUIC packet. In this case, for example, the information (for example, the acknowledgement number) for the acknowledgement for the transmitting apparatus 10 is included in an authenticated header of the ACK packet (QUIC packet) or an encrypted payload of the ACK packet (QUIC packet). As another example, the packet may be a QUIC frame (as that illustrated in FIG. 4, for example), and the ACK packet for the packet may also be a QUIC frame. In this case, the information (for example, the acknowledgement number) for the acknowledgement for the transmitting apparatus 10 may be included in an encrypted ACK packet (QUIC frame).

### (3) Control of Packets

The communication control apparatus 100 (the control section 160) performs control of the packets transmitted from the transmitting apparatus 10 to the receiving apparatus 20, that is, the control of causing the transmitting apparatus 10 to change a transmission rate.

For example, the control is control of the ACK packets for the packets or of the packets.

### (3-1) Control Based on Current Transmission Rate and Target Transmission Rate

### Estimation of Current Transmission Rate

For example, the communication control apparatus 100 (the current transmission rate estimation section 130) estimates the current transmission rate of the transmitting apparatus 10.

For example, the communication control apparatus 100 (the current transmission rate estimation section 130) estimates RTT based on time stamp information or the like that is included in a header of the packet received from the transmitting apparatus 10, and estimates a data amount (or a statistic value thereof) of the packet received during the RTT as the current transmission rate (cwnd) of the transmitting apparatus 10.

For example, as described above, the current transmission rate may be a data amount transmitted during the RTT. Alternatively, the current transmission rate may be a data amount (throughput) transmitted in unit time.

### Estimation of Target Transmission Rate

For example, the communication control apparatus 100 (the target transmission rate estimation section 140) estimates the target transmission rate of the transmitting apparatus 10.

For example, the communication control apparatus 100 (the target transmission rate estimation section 140) estimates an available band of the transmitting side network 30 (hereinafter referred to as a “first available band”) and an available band of the receiving side network 40 (hereinafter referred to as a “second available band”). Then, the communication control apparatus 100 (the target transmission rate estimation section 140) estimates, as the target transmission rate, one value (for example, the smaller value) out of the first value that is obtained by multiplying the first available band by the RTT and the second value that is obtained by multiplying the second available band by the RTT.

### Estimation of First Available Band (Available Band of Transmitting Side Network)

For example, the communication control apparatus 100 (the target transmission rate estimation section 140) may estimate any one of the following examples of the data packet received from the transmitting apparatus 10 as the first available band.

[First example] “(Size of data packet)/(reception interval of data packets)” (or a statistic value thereof)

[Second example] “(Size of packet group)/(time required for reception of packet group)” (or a statistic value thereof) (the packet group refers to a set of data packets that is received with the reception interval being a threshold or less or within a certain period of time)

### Estimation of Second Available Band (Available Band of Receiving Side Network)

As an example, the communication control apparatus 100 (the target transmission rate estimation section 140) may estimate any one of the following examples as the second available band.

[First example] “(Data amount whose arrival is confirmed with ACK packet)/(reception interval of ACK packets)” (or a statistic value thereof)

[Second example] “(Data amount whose arrival is confirmed with ACK packet group)/(time required for receive thereof)” (or a statistic value thereof) (the ACK packet group refers to a set of ACK packets that is received with the reception interval being a threshold or less or within a certain period of time)

[Third example] Reduction rate of data packets stored in the communication control apparatus 100

The communication control apparatus 100 (the target transmission rate estimation section 140) may estimate the second available band by storing the data packets received from the transmitting apparatus 10 and then collectively transmitting the data packets to the receiving side network 40 so as to transmit the data packets at a transmission rate that temporarily exceeds or is close to the second available band.

When estimating the second available band, the communication control apparatus 100 (the target transmission rate estimation section 140) may use past records about communication for receiving apparatuses that are presumed to have equivalent or similar network performance based on information such as a destination IP address or the like.

### Control Based on Estimation Results

For example, the communication control apparatus 100 (the control section 160) performs the control of the packets (control of causing the transmitting apparatus 10 to change the transmission rate), based on the current transmission rate and the target transmission rate.

For example, the communication control apparatus 100 (the control section 160) performs the control so that the transmission rate of the transmitting apparatus 10 becomes closer to the target transmission rate.

As an example, when the difference between the target transmission rate and the current transmission rate (target transmission rate - current transmission rate) is larger than a predetermined threshold (any positive number or zero), the communication control apparatus 100 (the control section 160) performs the control (control of causing the transmitting apparatus 10 to increase the transmission rate). When the difference between the current transmission rate and the target transmission rate (current transmission rate - target transmission rate) is larger than the predetermined threshold (any positive number or zero), the communication control apparatus 100 (the control section 160) may perform the control (control of causing the transmitting apparatus 10 to reduce the transmission rate).

As another example, the communication control apparatus 100 (the control section 160) may configure a control parameter according to the difference between the target transmission rate and the current transmission rate (target transmission rate - current transmission rate), and perform the control by using the control parameter.

### (3-2) First Example of Control: Adjustment of Transfer Timing

For example, the control includes adjustment of transmission timing of the ACK packets or the packets. In other words, the communication control apparatus 100 (the control section 160) performs adjustment of the transmission timing of the ACK packets or the packets.

### First Example

As a first example, the adjustment of the transmission timing includes reduction of a transmission interval between the ACK packets. In other words, the communication control apparatus 100 (the control section 160) reduces the transmission interval between the ACK packets.

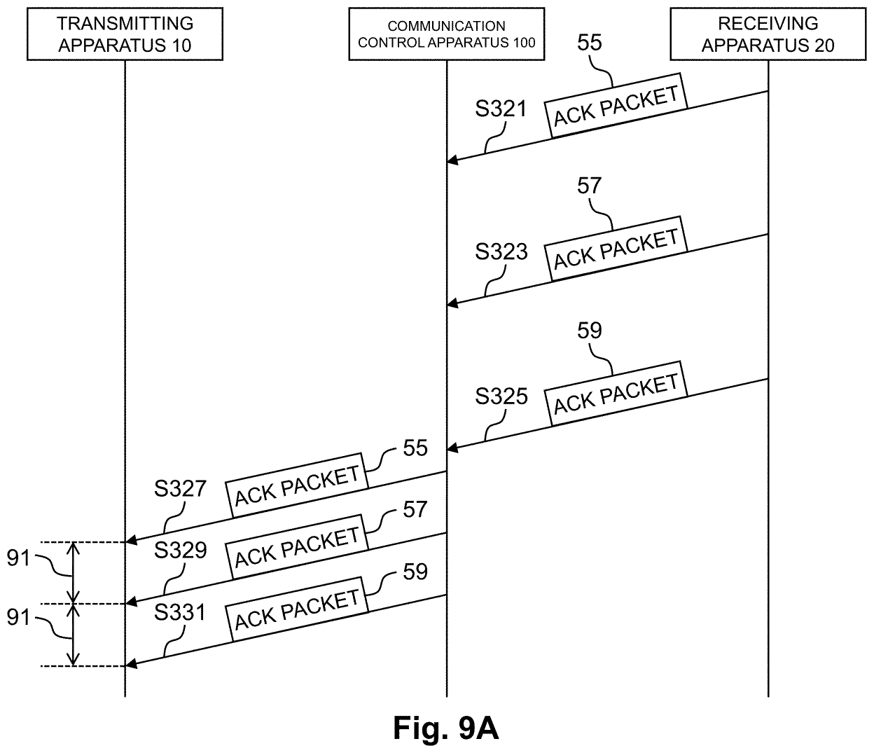

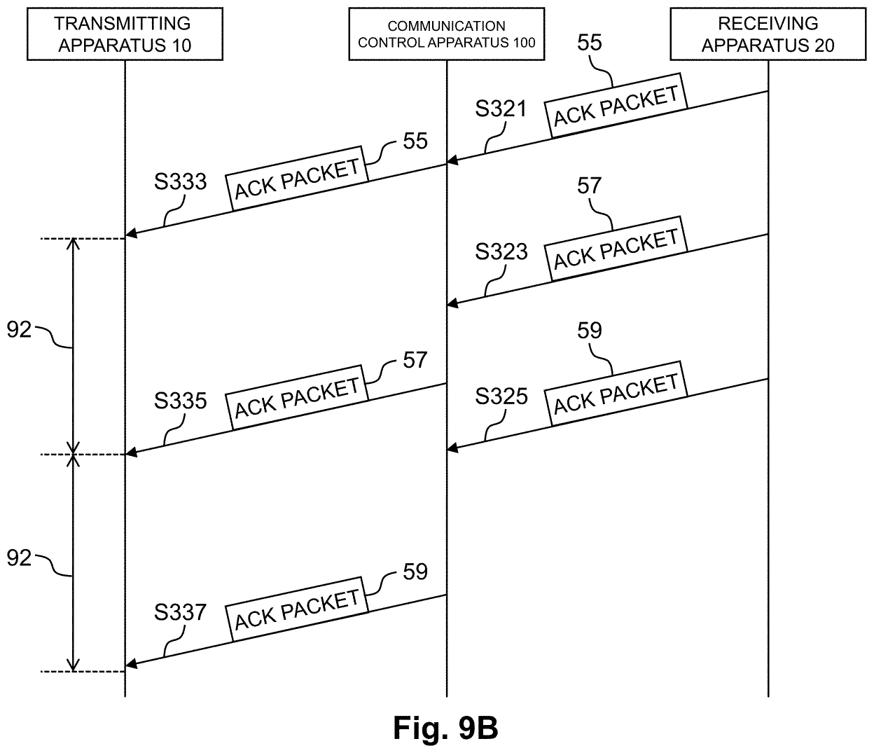

FIG. 9A is a sequence diagram for describing the first example of the adjustment of the transmission timing according to the first example embodiment. The communication control apparatus 100 (the second communication processing section 120) receives ACK packets 55, 57, and 59 from the receiving apparatus 20 (S321, S323, and S325). The communication control apparatus 100 stores each of the ACK packets 55, 57, and 59 without immediately transmitting the ACK packets 55, 57, and 59 to the transmitting apparatus 10, and transmits the ACK packets 55, 57, and 59 at a predetermined interval 91 (shorter interval). As a result, the transmitting apparatus 10 receives the ACK packets 55, 57, and 59 in a short period of time, and a large amount of acknowledged data is thus counted in such a short period of time in the transmitting apparatus 10. The predetermined interval 91 may be a control parameter that is determined in advance, or may be a control parameter that is configured by the communication control apparatus 100 (the control section 160).

This configuration can, for example, make the transmitting apparatus 10 assume that the data packets are collectively transmitted successfully. As a result, for example, when the transmitting apparatus 10 uses the function-based transmission control scheme (for example, BBR or the like), the maximum value of the available band can be increased and the transmission data amount can be increased. In other words, the transmission rate of the transmitting apparatus 10 can be increased, and throughput of the communication between the transmitting apparatus 10 and the receiving apparatus 20 can be enhanced.

Note that the adjustment of the transmission timing may include reduction of a transmission interval between the packets (data packets) (instead of the transmission interval between the ACK packets). In other words, the communication control apparatus 100 (the control section 160) may reduce the transmission interval between the packets (data packets). In this case as well, the transmission interval between the ACK packets is also reduced as a result. Therefore, similar effects can be obtained.

### Second Example

As a second example, the adjustment of the transmission timing includes increase of the transmission interval between the ACK packets. In other words, in the second example, in contrast to the first example, the communication control apparatus 100 (the control section 160) increases the transmission interval between the ACK packets.

FIG. 9B is a sequence diagram for describing the second example of the adjustment of the transmission timing according to the first example embodiment. The communication control apparatus 100 (the second communication processing section 120) receives ACK packets 55, 57, and 59 from the receiving apparatus 20 (S321, S323, and S325). The communication control apparatus 100 transmits the ACK packets 55, 57, and 59 at a predetermined interval 92 (long interval). As a result, the transmitting apparatus 10 receives the ACK packets 55, 57, and 59 in a long period of time, and the amount of acknowledged data to be counted per certain period is thus reduced in the transmitting apparatus 10. The predetermined interval 92 may be a control parameter that is determined in advance, or may be a control parameter that is configured by the communication control apparatus 100 (the control section 160).

This configuration can, for example, make the transmitting apparatus 10 assume that the data packets are transmitted little by little. As a result, for example, when the transmitting apparatus 10 uses the function-based transmission control scheme (for example, BBR or the like), the maximum value of the available band can be reduced and the transmission data amount can be reduced. In other words, the transmission rate of the transmitting apparatus 10 can be reduced, and throughput of the communication between the transmitting apparatus 10 and the receiving apparatus 20 can be reduced.

Note that the adjustment of the transmission timing may include increase of a transmission interval between the packets (data packets) (instead of the transmission interval between the ACK packets). In other words, the communication control apparatus 100 (the control section 160) may increase the transmission interval between the packets (data packets). In this case as well, the transmission interval between the ACK packets is also increased as a result. Therefore, similar effects can be obtained.

### Third Example

As another example, the adjustment of the transmission timing may include causing a delay of transmission of the ACK packets. The communication control apparatus 100 (the control section 160) may cause a delay of the transmission of the ACK packets.

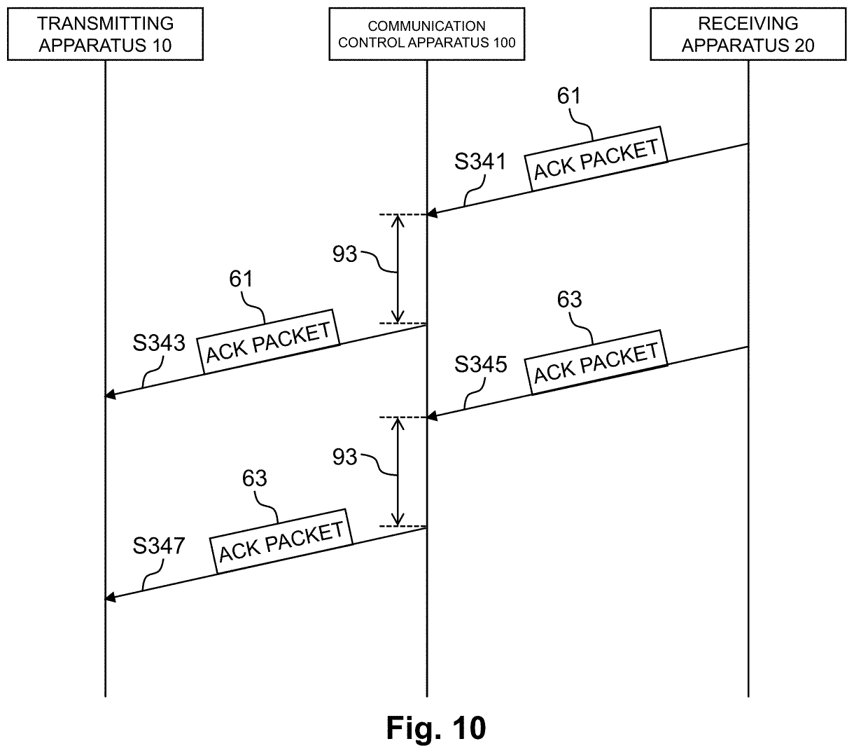

FIG. 10 is a sequence diagram for describing the third example of the adjustment of the transmission timing according to the first example embodiment. The communication control apparatus 100 (the second communication processing section 120) receives an ACK packet 61 from the receiving apparatus 20 (S341), but transmits the ACK packet 61 to the transmitting apparatus 10 after a predetermined time period 93 without immediately transmitting the ACK packet 61 to the transmitting apparatus 10 (S343). In a similar manner, the communication control apparatus 100 (the second communication processing section 120) receives an ACK packet 63 from the receiving apparatus 20 (S345), but transmits the ACK packet 63 to the transmitting apparatus 10 after the predetermined time period 93 without immediately transmitting the ACK packet 63 to the transmitting apparatus 10 (S347). The predetermined time period 93 may be a control parameter that is determined in advance, or may be a control parameter that is configured by the communication control apparatus 100 (the control section 160).

In this manner, for example, the RTT (the time from when the transmitting apparatus 10 transmits the packet to when the transmitting apparatus 10 receives the ACK) can be increased. For example, when the transmitting apparatus 10 uses the loss-based scheme (for example, CUBIC or the like), retransmission permission standby time is increased as a result (for example, the value of Retransmission Time Out (RTO) is increased). Thus, at the time of occurrence of a sudden delay, retransmission and reduction of a transmission rate due to the retransmission can be avoided. Alternatively, when the transmitting apparatus 10 uses the function-based transmission control scheme (for example, BBR or the like), an estimated communication delay is increased as a result. Thus, the transmission data amount can be increased. In other words, the transmission rate of the transmitting apparatus 10 can be increased, and throughput of the communication between the transmitting apparatus 10 and the receiving apparatus 20 can be enhanced.

Note that the adjustment of the transmission timing may include causing a delay of transmission of the packets (data packets) (instead of the ACK packets). In this case as well, the RTT is increased as a result. Therefore, similar effects can be obtained.

### (3-3) Second Example of Control: Adjustment of Transfer Order

For example, the control includes adjustment of transmission order of the packets. In other words, the communication control apparatus 100 (the control section 160) performs adjustment of the transmission order of the packets.

Specifically, for example, the adjustment of the transmission order refers to making an adjustment of the transmission order of the packets so that the packets are transmitted in sequence order instead of received order. In other words, the communication control apparatus 100 (the control section 160) adjusts the transmission order of the packets so that the packets are transmitted in sequence order instead of received order. For example, the communication control apparatus 100 (the control section 160) adjusts the transmission order of the packets so that the packets buffered in the communication control apparatus 100 are transmitted in the sequence order.

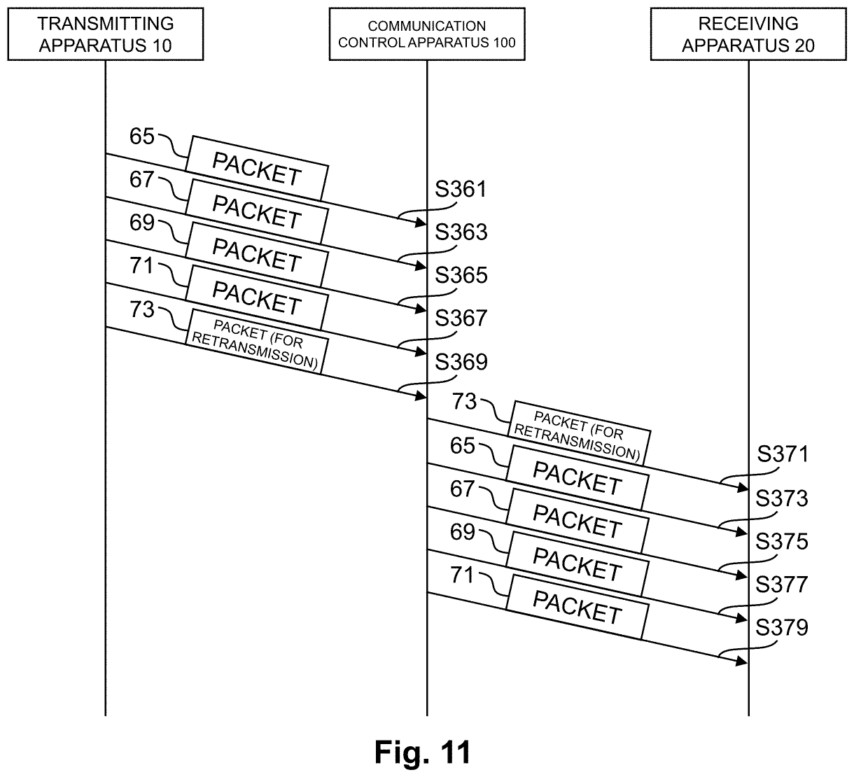

FIG. 11 is a sequence diagram for describing an example of the adjustment of the transmission order of the packets according to the first example embodiment. The transmitting apparatus 10 transmits packets 65, 67, 69, 71, and 73 (S361 to S371), and the communication control apparatus 100 receives and buffers the packets 65, 67, 69, 71, and 73. The packets 65, 67, 69, and 71 are new packets, whereas the packet 73 is a retransmission packet. Thus, among the packets 65, 67, 69, 71, and 73, the packet 73 (retransmission packet) is the last packet in the received order but is the first packet in the sequence order. Thus, the communication control apparatus 100 first transmits the packet 73 (retransmission packet) to the receiving apparatus 20 (S371), and subsequently transmits the packets 65, 67, 69, and 71 to the receiving apparatus 20 in the sequence order (S373 to S379).

In this manner, for example, the retransmission packets can be preferentially transferred. As a result, at the time of occurrence of packet loss, the retransmission packets change its state to be acknowledged packets sooner, which allows for sooner reduction of the amount of packets remaining in a transmission window. Consequently, a larger number of new packets can be transmitted. In other words, the transmission rate of the transmitting apparatus 10 can be increased, and throughput of the communication between the transmitting apparatus 10 and the receiving apparatus 20 can be enhanced.

When the packets transmitted from the transmitting apparatus 10 do not arrive the communication control apparatus 100 in the sequence order, the packets can be transmitted in order. Thus, the packets are more likely to arrive the receiving apparatus 20 in sequence order, and the duplicate acknowledgements (DupACKs) for the same packets are less likely to be generated. For example, when the transmitting apparatus 10 uses the loss-based transmission control scheme (for example, CUBIC or the like), a plurality of (for example, three or more) consecutive duplicate acknowledgements (DupACKs) for the same packets are less likely to be generated, and reduction of the transmission rate (for example, reduction of cwnd) can thus be prevented. In other words, throughput of the communication between the transmitting apparatus 10 and the receiving apparatus 20 can be enhanced.

### (3-4) Third Example of Control: Discarding of Part of ACK Packets

For example, the control includes discarding of a part of the ACK packets. In other words, the communication control apparatus 100 (the control section 160) performs discarding of a part of the ACK packets.

For example, the discarding refers to discarding of acknowledgement packets at a predetermined probability, at a predetermined ratio, or at a predetermined time interval. In other words, the communication control apparatus 100 (the control section 160) discards the ACK packets at a predetermined probability, at a predetermined ratio, or at a predetermined time interval. The predetermined probability, the predetermined ratio, and the predetermined time interval may each be a control parameter that is determined in advance, or may each be a control parameter that is configured by the communication control apparatus 100 (the control section 160).

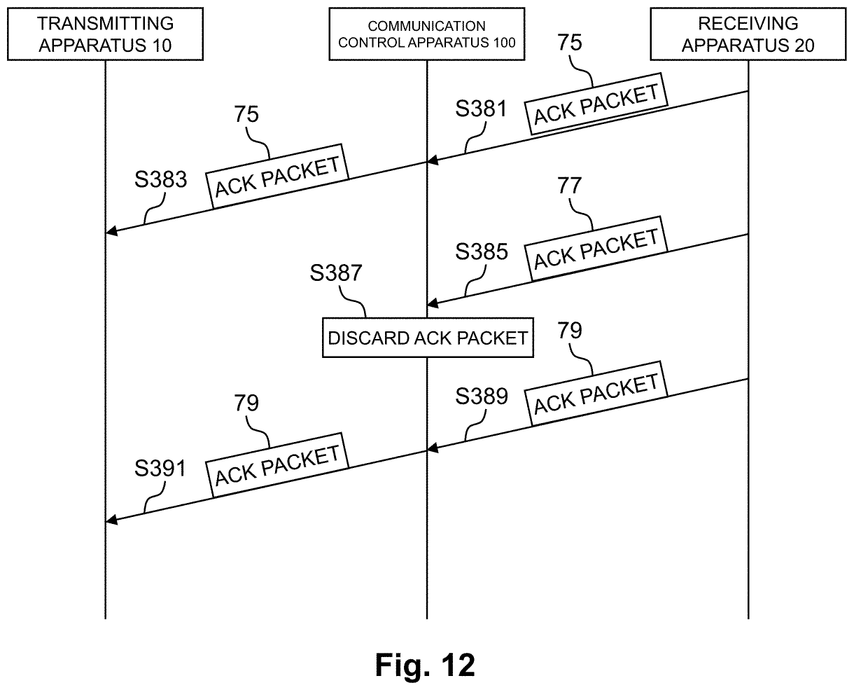

FIG. 12 is a sequence diagram for describing an example of the discarding of a part of the ACK packets according to the first example embodiment. The receiving apparatus 20 transmits an ACK packet 75 to the transmitting apparatus 10 (S381 and S383). The communication control apparatus 100 receives the ACK packet 75 from the receiving apparatus 20 (S381), and transmits the ACK packet 75 to the transmitting apparatus 10 (S383). The receiving apparatus 20 transmits an ACK packet 77 to the transmitting apparatus 10 (S385). However, the communication control apparatus 100 receives the ACK packet 77 from the receiving apparatus 20 (S385), and discards the ACK packet 77 (S387). The receiving apparatus 20 transmits an ACK packet 79 to the transmitting apparatus 10 (S389 and S391). The communication control apparatus 100 receives the ACK packet 79 from the receiving apparatus 20 (S389), and transmits the ACK packet 79 to the transmitting apparatus 10 (S391). As a result, in the transmitting apparatus 10, with the reception of the ACK packet 79, a large amount of acknowledged data is counted at a time.

This configuration can, for example, make the transmitting apparatus 10 assume that the data packets are collectively transmitted successfully. As a result, for example, when the transmitting apparatus 10 uses the function-based transmission control scheme (for example, BBR or the like), the maximum value of the available band can be increased and the transmission data amount can be increased. In other words, the transmission rate of the transmitting apparatus 10 can be increased, and throughput of the communication between the transmitting apparatus 10 and the receiving apparatus 20 can be enhanced.

Even when the duplicate acknowledgements (DupACKs) for the same packets are generated, a plurality of (for example, three or more) consecutive duplicate acknowledgements (DupACKs) for the same packets are less likely to be received by the transmitting apparatus 10. Thus, for example, when the transmitting apparatus 10 uses the loss-based transmission control scheme (for example, CUBIC or the like), reduction of the transmission rate (for example, reduction of cwnd) can be prevented. In other words, throughput of the communication between the transmitting apparatus 10 and the receiving apparatus 20 can be enhanced.

### (3-5) First, Second, and Third Examples of Control

As the control, the above has described the adjustment of the transmission timing of the ACK packets or the packets, the adjustment of the transmission order of the packets, and the discarding of a part of the ACK packets. The control may include all of the adjustment of the transmission timing, the adjustment of the transmission order, and the discarding of a part of the ACK packets, or may include only a part thereof. For example, the control may be one of the adjustment of the transmission timing, the adjustment of the transmission order, and the discarding of a part of the ACK packets.

### (3-6) Additional Notes

The communication control apparatus 100 (the transmission control estimation section 150, the control section 160) may estimate the transmission control scheme used by the transmitting apparatus 10, and perform the control based on the estimated transmission control scheme.

For example, the communication control apparatus 100 (the control section 160) may select control (for example, the adjustment of the transmission timing, the adjustment of the transmission order, or the discarding of a part of the ACK packets) that is adaptable to the estimated transmission control scheme, and execute the selected control. Alternatively, the communication control apparatus 100 (the control section 160) may select a control parameter that is adaptable to the estimated transmission control scheme, and perform control by using the control parameter.

In this manner, for example, the transmission rate of the transmitting apparatus 10 can be changed more appropriately.

In the above, the first example embodiment has been described. According to the first example embodiment, as has been described in the above, throughput of the communication between the transmitting apparatus 10 and the receiving apparatus 20 can be enhanced regardless of a protocol to be used.

### 4. SECOND EXAMPLE EMBODIMENT

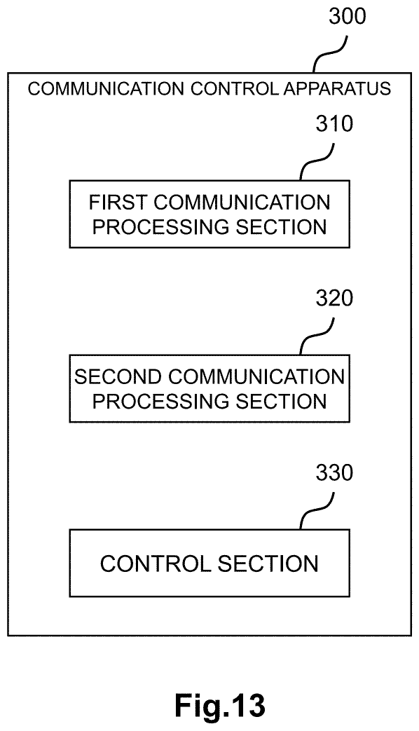

With reference to FIG. 13, a second example embodiment of the present invention will be described. The above-described first example embodiment is a concrete example embodiment, whereas the second example embodiment is a more generalized example embodiment.

### 4.1. Functional Configuration of Communication Control Apparatus

FIG. 13 is a block diagram illustrating an example of a schematic functional configuration of a communication control apparatus 300 according to the second example embodiment. With reference to FIG. 13, the communication control apparatus 300 includes a first communication processing section 310, a second communication processing section 320, and a control section 330.

The first communication processing section 310 transmits and receives packets. For example, the first communication processing section 310 receives packets (for example, data packets) from the transmitting apparatus 10, and transmits packets (for example, ACK packets) to the transmitting apparatus 10.

The second communication processing section 320 transmits and receives packets. For example, the second communication processing section 320 transmits packets (for example, data packets) to the receiving apparatus 20, and receives packets (for example, ACK packets) from the receiving apparatus 20.

The control section 330 performs control of the packets transmitted from the transmitting apparatus to the receiving apparatus. For example, the control is control of the ACK packets (the ACK packets that are received by the second communication processing section 320 from the receiving apparatus 20 and are transmitted by the first communication processing section 310 to the transmitting apparatus 10) for the packets, or of the packets (the data packets that are received by the first communication processing section 310 from the transmitting apparatus 10 and are transmitted by the second communication processing section 320 to the receiving apparatus 20). The control section 330 may perform indirect control of the ACK packets or the packets by controlling operation of the first communication processing section 310 or the second communication processing section 320. Alternatively, the control section 330 may perform direct control of the ACK packets or the packets by directly processing the ACK packets or the packets between the first communication processing section 310 and the second communication processing section 320.

More specific operations of the first communication processing section 310, the second communication processing section 320, and the control section 330 will be described later as technical features of the second example embodiment.

### 4.2. Hardware Configuration of Communication Control Apparatus

A hardware configuration of the communication control apparatus 300 according to the second example embodiment is the same as the hardware configuration of the communication control apparatus 100 according to the first example embodiment, for example. Hence, overlapping descriptions are omitted here.

### 4.3. Technical Features

Technical features of the second example embodiment will be described.

### (1) Relay of Packets

The communication control apparatus 300 (the first communication processing section 310) receives, from the transmitting apparatus 10, the packets transmitted from the transmitting apparatus 10 to the receiving apparatus 20. Then, the communication control apparatus 300 (the second communication processing section 320) transmits the packets to the receiving apparatus 20.

The description according to the second example embodiment in this regard is, for example, the same as the description according to the first example embodiment in the same regard (except for the difference of the reference signs). Hence, overlapping descriptions are omitted here. However, as a matter of course, the second example embodiment is not limited to the example described above.

### (2) Packets and Acknowledgement (ACK) Packets

The packets transmitted from the transmitting apparatus 10 to the receiving apparatus 20 are packets that cannot be generated and modified in a relay point (for example, the communication control apparatus 300 or the like) between the transmitting apparatus 10 and the receiving apparatus 20.

In addition, the acknowledgement (ACK) packets for the packets are ACK packets that cannot be generated and modified in a relay point between the receiving apparatus 20 and the transmitting apparatus 10.

The description according to the second example embodiment in this regard is, for example, the same as the description according to the first example embodiment in the same regard (except for the difference of the reference signs). Hence, overlapping descriptions are omitted here. However, as a matter of course, the second example embodiment is not limited to the example described above.

### (3) Control of Packets

The communication control apparatus 300 (the control section 330) performs control of the packets transmitted from the transmitting apparatus 10 to the receiving apparatus 20, the control causing the transmitting apparatus 10 to change a transmission rate.

The description according to the second example embodiment in this regard is, for example, the same as the description according to the first example embodiment in the same regard (except for the difference of the reference signs). Hence, overlapping descriptions are omitted here. However, as a matter of course, the second example embodiment is not limited to the example described above.

In the above, the second example embodiment has been described. According to the second example embodiment, throughput of the communication between the transmitting apparatus 10 and the receiving apparatus 20 can be enhanced regardless of a protocol to be used.

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus (for example, a module) that includes the constituent elements of the communication control apparatus described in the Specification (for example, the first communication processing section, the second communication processing section, the current transmission rate estimation section, the target transmission rate estimation section, the transmission control estimation section, and/or the control section) may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as, but not limited to, the following supplementary notes.

### Supplementary Note 1

A communication control apparatus comprising:

a first communication processing section configured to receive one or more packets from a transmitting apparatus, the one or more packets being transmitted from the transmitting apparatus to a receiving apparatus and being unable to be generated and modified at a relay point between the transmitting apparatus and the receiving apparatus; and

a second communication processing section configured to transmit the one or more packets to the receiving apparatus,

wherein the second communication processing section receives, from the receiving apparatus, one or more acknowledgement packets for the one or more packets, the one or more acknowledgement packets being unable to be generated and modified at a relay point between the receiving apparatus and the transmitting apparatus, and

wherein the first communication processing section transmits the one or more acknowledgement packets to the transmitting apparatus,

the communication control apparatus further comprising

a control section configured to perform control of the one or more packets or the one or more acknowledgement packets so that the transmitting apparatus changes a transmission rate.

### Supplementary Note 2

The communication control apparatus according to supplementary note 1, wherein

the control includes adjustment of transmission timing of the one or more acknowledgement packets or the one or more packets.

### Supplementary Note 3

The communication control apparatus according to supplementary note 2, wherein

the adjustment of the transmission timing includes reduction or increase of a transmission interval between the acknowledgement packets or a transmission interval between the packets.

### Supplementary Note 4

The communication control apparatus according to supplementary note 2 or 3, wherein

the adjustment of the transmission timing includes causing a delay of transmission of the one or more acknowledgement packets or the one or more packets.

### Supplementary Note 5

The communication control apparatus according to any one of supplementary notes 1 to 4, wherein

the control includes discarding of a part of the acknowledgement packets.

### Supplementary Note 6

The communication control apparatus according to supplementary note 5, wherein

the discarding is discarding of the acknowledgement packets at a predetermined probability, at a predetermined ratio, or at a predetermined time interval.

### Supplementary Note 7

The communication control apparatus according to any one of supplementary notes 1 to 6, wherein

the control includes adjustment of transmission order of the packets.

### Supplementary Note 8

The communication control apparatus according to supplementary note 7, wherein

the adjustment of the transmission order is making an adjustment of the transmission order of the packets so that the packets are transmitted in sequence order instead of received order.

### Supplementary Note 9

The communication control apparatus according to any one of supplementary notes 1 to 8, wherein

at least part of the packets is encrypted or authenticated, and

at least part of the acknowledgement packets is encrypted or authenticated.

### Supplementary Note 10

The communication control apparatus according to supplementary note 9, wherein

the at least part of the acknowledgement packets includes information for acknowledgement for the transmitting apparatus.

### Supplementary Note 11

The communication control apparatus according to any one of supplementary notes 1 to 10, further comprising

a target transmission rate estimation section configured to estimate a target transmission rate between the transmitting apparatus and the receiving apparatus,

wherein the control section performs the control, based on the target transmission rate.

### Supplementary Note 12

The communication control apparatus according to supplementary note 11, further comprising

a current transmission rate estimation section configured to estimate a current transmission rate between the transmitting apparatus and the receiving apparatus,

wherein the control section performs the control based on the current transmission rate and the target transmission rate.

### Supplementary Note 13

The communication control apparatus according to any one of supplementary notes 1 to 12, further comprising

a transmission control estimation section configured to estimate a transmission control scheme used by the transmitting apparatus,

wherein the control section performs the control based on the transmission control scheme estimated.

### Supplementary Note 14

The communication control apparatus according to any one of supplementary notes 1 to 13, wherein

the transmitting apparatus is a transmitting apparatus configured to use a first transmission control scheme or a second transmission control scheme,

the first transmission control scheme is a transmission control scheme of controlling the transmission rate, based on whether or not packet loss occurs, and

the second transmission control scheme is a transmission control scheme of controlling the transmission rate, based on network performance estimated from transmission and reception of the one or more packets.

### Supplementary Note 15

The communication control apparatus according to any one of supplementary notes 1 to 14, wherein

the one or more packets are one or more data packets.

### Supplementary Note 16

A method comprising:

receiving one or more packets from a transmitting apparatus, the one or more packets being transmitted from the transmitting apparatus to a receiving apparatus and being unable to be generated and modified at a relay point between the transmitting apparatus and the receiving apparatus;

transmitting the one or more packets to the receiving apparatus;

receiving, from the receiving apparatus, one or more acknowledgement packets for the one or more packets, the one or more acknowledgement packets being unable to be generated and modified at a relay point between the receiving apparatus and the transmitting apparatus;

transmitting the one or more acknowledgement packets to the transmitting apparatus; and

performing control of the one or more packets or the one or more acknowledgement packets so that the transmitting apparatus changes a transmission rate.

### Supplementary Note 17

A program that causes a processor to execute:

receiving one or more packets from a transmitting apparatus, the one or more packets being transmitted from the transmitting apparatus to a receiving apparatus and being unable to be generated and modified at a relay point between the transmitting apparatus and the receiving apparatus;

transmitting the one or more packets to the receiving apparatus;

receiving, from the receiving apparatus, one or more acknowledgement packets for the one or more packets, the one or more acknowledgement packets being unable to be generated and modified at a relay point between the receiving apparatus and the transmitting apparatus;

transmitting the one or more acknowledgement packets to the transmitting apparatus; and

performing control of the one or more packets or the one or more acknowledgement packets so that the transmitting apparatus changes a transmission rate.

### Supplementary Note 18

A non-transitory computer readable recording medium storing a program that causes a processor to execute:

receiving one or more packets from a transmitting apparatus, the one or more packets being transmitted from the transmitting apparatus to a receiving apparatus and being unable to be generated and modified at a relay point between the transmitting apparatus and the receiving apparatus;

transmitting the one or more packets to the receiving apparatus;

receiving, from the receiving apparatus, one or more acknowledgement packets for the one or more packets, the one or more acknowledgement packets being unable to be generated and modified at a relay point between the receiving apparatus and the transmitting apparatus;

transmitting the one or more acknowledgement packets to the transmitting apparatus; and

performing control of the one or more packets or the one or more acknowledgement packets so that the transmitting apparatus changes a transmission rate.

This application claims priority based on JP 2018-129929 filed on Jul. 9, 2018, the entire disclosure of which is incorporated herein.

### REFERENCE SIGNS LIST

1 System
10 Transmitting apparatus
20 Receiving apparatus
100, 300 Communication control apparatus
110, 310 First communication processing section
120, 320 Second communication processing section
130 Current transmission rate estimation section
140 Target transmission rate estimation section
150 Transmission control estimation section
160, 330 Control section

What is claimed is:

1. A communication control apparatus comprising:
a memory storing instructions; and
one or more processors configured to execute the instructions to:
receive one or more packets from a transmitting apparatus, the one or more packets being transmitted from the transmitting apparatus to a receiving apparatus and being unable to be generated and modified at a relay point between the transmitting apparatus and the receiving apparatus;
transmit the one or more packets to the receiving, apparatus;
receive, from the receiving apparatus, one or more acknowledgement packets for the one or more packets, the one or more acknowledgement packets being unable to be generated and modified at a relay point between the receiving apparatus and the transmitting apparatus;
transmit the one or more acknowledgement packets to the transmitting apparatus; and
perform control of the one or more packets or the one or more acknowledgement packets so that the transmitting apparatus changes a transmission rate.

2. The communication control apparatus according to claim 1, wherein
the control includes adjustment of transmission timing of the one or more acknowledgement packets or the one or more packets.

3. The communication control apparatus according to claim 2, wherein
the adjustment of the transmission timing includes reduction or increase of a transmission interval between the acknowledgement packets or a transmission interval between the packets.

4. The communication control apparatus according to claim 2, wherein
the adjustment of the transmission timing includes causing a delay of transmission of the one or more acknowledgement packets or the one or more packets.

5. The communication control apparatus according to claim 1, wherein
the control includes discarding of a part of the acknowledgement packets.

6. The communication control apparatus according to claim 5, wherein
the discarding is discarding of the acknowledgement packets at a predetermined probability, at a predetermined ratio, or at a predetermined time interval.

7. The communication control apparatus according to claim 1, wherein
the control includes adjustment of transmission order of the packets.

8. The communication control apparatus according to claim 7, wherein
the adjustment of the transmission order is making an adjustment of the transmission order of the packets so that the packets are transmitted in sequence order instead of received order.

9. The communication control apparatus according to claim 1, wherein
at least part of the packets is encrypted or authenticated, and
at least part of the acknowledgement packets is encrypted or authenticated.

10. The communication control apparatus according to claim 9, wherein
the at least part of the acknowledgement packets includes information for acknowledgement for the transmitting apparatus.

11. The communication control apparatus according to claim 1, wherein the one or more processors are configured to execute the instructions to:
estimate a target transmission rate between the transmitting apparatus and the receiving apparatus,
wherein the control is performed based on the target transmission rate.

12. The communication control apparatus according to claim 11, wherein the one or more processors are configured to execute the instructions to:
estimate a current transmission rate between the transmitting apparatus and the receiving apparatus,
wherein the control is performed based on the current transmission rate and the target transmission rate.

13. The communication control apparatus according to claim 1, wherein the one or more processors are configured to execute the instructions to:
estimate a transmission control scheme used by the transmitting apparatus,
wherein the control is performed based on the transmission control scheme estimated.

14. The communication control apparatus according to claim 1, wherein
the transmitting apparatus is a transmitting apparatus configured to use a first transmission control scheme or a second transmission control scheme,
the first transmission control scheme is a transmission control scheme of controlling the transmission rate, based on whether or not packet loss occurs, and
the second transmission control scheme is a transmission control scheme of controlling the transmission rate, based on network performance estimated from transmission and reception of the one or more packets.

15. The communication control apparatus according to claim 1, wherein
the one or more packets are one or more data packets.

16. A method comprising:
receiving one or more packets from a transmitting apparatus, the one or more packets being transmitted from the transmitting apparatus to a receiving apparatus and being unable to be generated and modified at a relay point between the transmitting apparatus and the receiving apparatus;
transmitting the one or more packets to the receiving apparatus;
receiving, from the receiving apparatus, one or more acknowledgement packets for the one or more packets, the one or more acknowledgement packets being unable to be generated and modified at a relay point between the receiving apparatus and the transmitting apparatus;
transmitting the one or more acknowledgement packets to the transmitting apparatus; and
performing control of the one or more packets or the one or more acknowledgement packets so that the transmitting apparatus changes a transmission rate.

17. (canceled)

18. A non-transitory computer readable recording medium storing a program that causes a processor to execute:
receiving one or more packets from a transmitting apparatus, the one or more packets being transmitted from the transmitting apparatus to a receiving apparatus and being unable to be generated and modified at a relay point between the transmitting apparatus and the receiving apparatus;
transmitting the one or more packets to the receiving apparatus;
receiving, from the receiving apparatus, one or more acknowledgement packets for the one or more packets, the one or more acknowledgement packets being unable to be generated and modified at a relay point between the receiving apparatus and the transmitting apparatus;
transmitting the one or more acknowledgement packets to the transmitting apparatus; and
performing control of the one or more packets or the one or more acknowledgement packets so that the transmitting apparatus changes a transmission rate.
